(19) United States
(12) Patent Application Publication
(10) Pub. No.: US 2016/0048295 A1
(43) Pub. Date: Feb. 18, 2016

(54) DESKTOP ICON MANAGEMENT METHOD AND SYSTEM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW); HAI-SEN LIANG, Shenzhen (CN)

(21) Appl. No.: 14/527,255

(22) Filed: Oct. 29, 2014

(30) Foreign Application Priority Data
Aug. 12, 2014 (CN) 201410393908.3

(51) Int. Cl. G06F 3/0481; G06F 3/0484; G06F 3/0482

(52) U.S. Cl. CPC G06F 3/04817; G06F 3/0482; G06F 3/04842

(57) ABSTRACT

A method and system are provided for managing icons on a graphical user interface (GUI) desktop in a computer system. When it is detected that a press-and-hold input is made with respect to a desktop icon, a first menu is displayed. The first menu includes a first menu item. When the first menu item is selected by a user, a second menu is displayed. The second menu includes a second menu item. When the second menu item is selected, the desktop icon is replaced with another icon.

### CROSS-REFERENCE TO RELATED APPLICATIONS

This application claims priority to Chinese Patent Application No. 201410393908.3 filed on Aug. 12, 2014, the contents of which are hereby incorporated by reference.

### FIELD

The disclosure generally relates to the field of graphical user interface (GUI) management, and more particularly relates to methods and systems for managing icons on a GUI desktop in a computer system.

### BACKGROUND

Many computer systems use graphical user interfaces (GUIs) and icons to permit operators to use various applications largely without training. When used with a pointer device such as a mouse or a touch screen, the icons permit operators simply to point and click on an icon to start a computer application. When a new application is installed on a computer, a new icon is typically associated with the new application and placed on a GUI desktop, a computer workspace that is displayed when there are no open applications that overlay it. However, it is inconvenient for a user to modifying the desktop icon in the known computer system.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of a computing device suitable for implementing a desktop icon management system.

FIG. 2 is a block diagram of an embodiment of a desktop icon management system.

FIG. 3 is a flowchart of an embodiment of a desktop icon management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

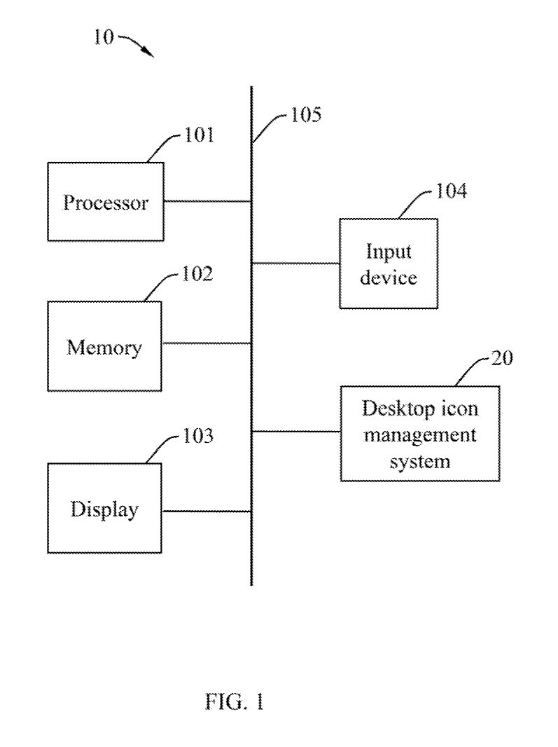

FIG. 1 illustrates a block diagram of an embodiment of a computing device 10 suitable for implementing a desktop icon management system 20. The computing device 10 can be, but is not limited to, a personal computer, a laptop computer, a smartphone, a personal digital assistant (PDA), a tablet computer, or any other type of computing device.

As is illustrated, the computing device 10 can include at least one processor 101, a suitable amount of memory 102, a display 103, and at least one input device 104. The computing device 10 can include additional elements, components, and modules, and be functionally configured to support various features that are unrelated to the subject matter described herein. In practice, the elements of the computing device 10 can be coupled together via a bus or any suitable interconnection architecture 105.

The processor 101 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The memory 102 can be realized as RAM memory, flash memory, EPROM memory, EEPROM memory, registers, a hard disk, a removable disk, a CD-ROM, or any other form of storage medium known in the art. The memory 102 is coupled to the processor 101, such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 103 can be suitably configured to enable the electronic device 10 to render and display various screens, GUIs, GUI control elements, menus, texts, or images, for example. The display 103 can also be utilized for the display of other information during operation of the electronic device 10, as is well understood.

The input device 104 can provide an input interface between the computing device 10 and a user. The input device 104 can be a mouse, a keyboard, a touchpad, or any other suitable type of input device.

The desktop icon management system 20 can be implemented in the electronic device 10 using software, firmware, or other computer programming technologies.

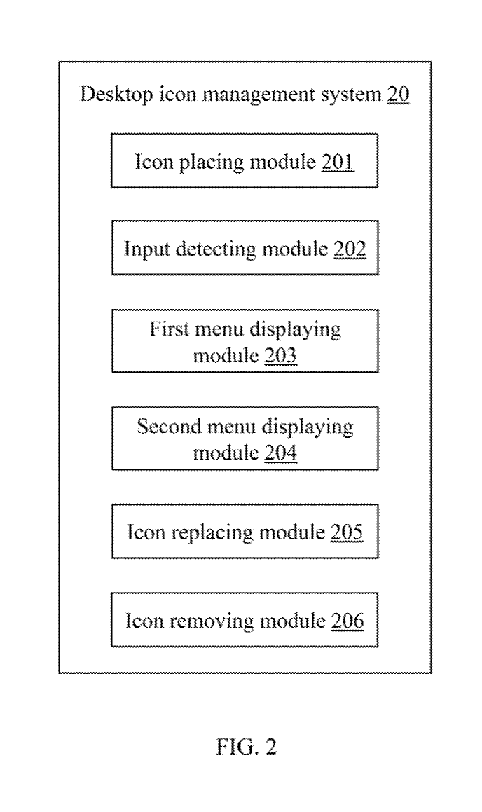

FIG. 2 illustrates a block diagram of an embodiment of the desktop icon management system 20 implemented in the electronic device 10. The desktop icon management system 20 can include an icon placing module 201, an input detecting module 202, a first menu displaying module 203, a second menu displaying module 204, an icon replacing module 205, and an icon removing module 206.

The icon placing module 201 can place a first icon on a GUI desktop. The GUI desktop can be provided by an operating system (OS) installed in the computing device 10.

The input detecting module 202 can detect whether a press-and-hold input is made with respect to the first icon. The press-and-hold input is a press or touch selection sustained for a pre-determined time period. The press-and-hold input can be made via either a mouse pointer or a touch-sensitive interface.

When the input detecting module 202 detects that a press-and-hold input is made with respect to the first icon, the first menu displaying module 203 can display a first menu on the GUI desktop. The first menu can include a modifying item and a removing item. In one embodiment, the first menu displaying module 203 can display the first menu in a region of the GUI desktop adjacent to the first icon.

When a user selects the removing item of the first menu, the icon removing module 206 can remove the first icon from the GUI desktop.

When the user selects the modifying item of the first menu, the second menu displaying module 204 can display a second menu on the GUI desktop. The second menu can include a second menu item. In one embodiment, the second menu displaying module 204 can display the second menu in a region of the GUI desktop adjacent to the modifying item of the first menu.

When the user selects the second menu item of the second menu, the icon replacing module 205 can replace the first icon with a second icon on the GUI desktop.

In one embodiment, when the user selects the second menu item of the second menu, the icon replacing module 205 can display a list of application programs. When one of the application programs is selected from the list, the icon replacing module 205 can replace the first icon with a shortcut icon of the selected application program.

In another embodiment, when the user selects the second menu item of the second menu, the icon replacing module 205 can display a list of pictures. When one of the pictures is selected from the list, the icon replacing module 205 can replace the first icon with a thumbnail icon of the selected picture.

In another embodiment, when the user selects the second menu item of the second menu, the icon replacing module 205 can display a list of videos. When one of the videos is selected from the list, the icon replacing module 205 can replace the first icon with a thumbnail icon of the selected video. The icon replacing module 205 can capture a video frame from the selected video and consider the video frame as the thumbnail icon of the selected video.

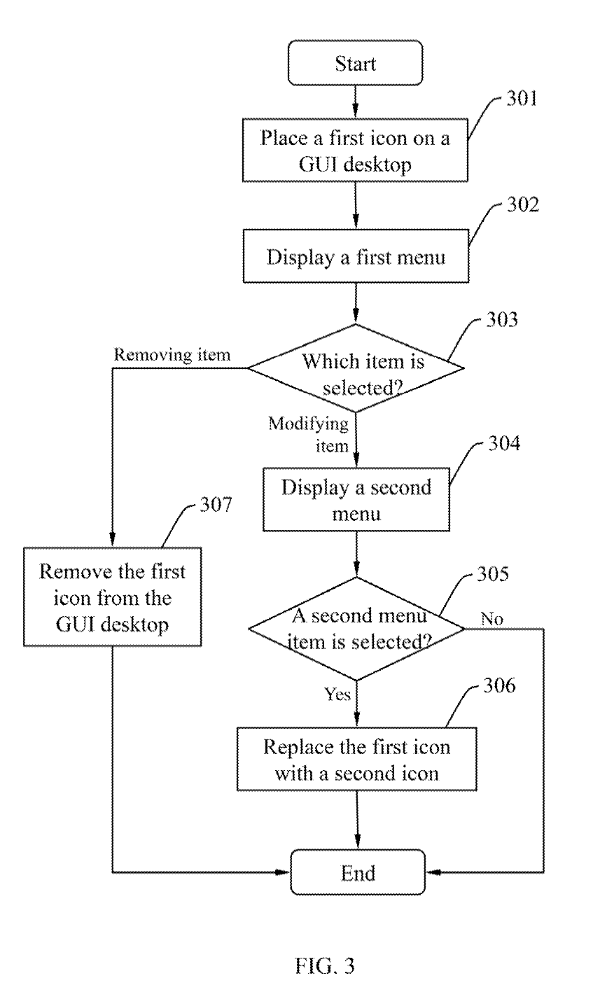

Referring to FIG. 3, a flowchart of a desktop icon management method is presented in accordance with an example embodiment which is being thus illustrated. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 3 represents one or more processes, methods or subroutines, carried out in the exemplary method. Additionally, the illustrated order of blocks is by example only and the order of the blocks can change according to the present disclosure. The exemplary method can begin at block 301.

At block 301, an icon placing module 201 places a first icon on a GUI desktop.

At block 302, an input detecting module 202 detects whether a press-and-hold input is made with respect to the first icon. When the input detecting module 202 detects that a press-and-hold input is made with respect to the first icon, the first menu displaying module 203 displays a first menu on the GUI desktop. The first menu includes a modifying item and a removing item. In one embodiment, the first menu displaying module 203 displays the first menu in a region of the GUI desktop adjacent to the first icon.

At block 303, if a user selects the removing item of the first menu, block 307 is implemented. If the user selects the modifying item of the first menu, block 304 is implemented.

At block 304, a second menu displaying module 204 displays a second menu on the GUI desktop. The second menu includes a second menu item. In one embodiment, the second menu displaying module 204 displays the second menu in a region of the GUI desktop adjacent to the modifying item of the first menu.

At block 305, if the second item of the second menu is selected, block 306 is implemented. Otherwise, the flow ends.

At block 306, an icon replacing module 205 replaces the first icon with a second icon on the GUI desktop.

In one embodiment, when the user selects the second menu item of the second menu, the icon replacing module 205 displays a list of application programs. When one of the application programs is selected from the list, the icon replacing module 205 replaces the first icon with a shortcut icon of the selected application program.

In another embodiment, when the user selects the second menu item of the second menu, the icon replacing module 205 displays a list of pictures. When one of the pictures is selected from the list, the icon replacing module 205 replaces the first icon with a thumbnail icon of the selected picture.

In another embodiment, when the user selects the second menu item of the second menu, the icon replacing module 205 displays a list of videos. When one of the videos is selected from the list, the icon replacing module 205 replaces the first icon with a thumbnail icon of the selected video. The icon replacing module 205 captures a video frame from the selected video and considers the video frame as the thumbnail icon of the selected video.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A desktop icon management method, comprising:
placing a first icon on a graphical user interface (GUI) desktop;
detecting whether a press-and-hold input is made with respect to the first icon;
displaying a first menu when the press-and-hold input is made with respect to the first icon, the first menu comprising a first menu item;
displaying a second menu when the first menu item is selected, the second menu comprising a second menu item; and
replacing the first icon with a second icon on the GUI desktop when the second menu item is selected.

2. The desktop icon management method of claim 1, wherein the replacing the first icon with the second icon comprising:
displaying a list of application programs; and
when one of the application programs is selected from the list, replacing the first icon with a shortcut icon of the selected application program.

3. The desktop icon management method of claim 1, wherein the replacing the first icon with the second icon comprising:
displaying a list of pictures; and
when one of the pictures is selected from the list, replacing the first icon with a thumbnail icon of the selected picture.

4. The desktop icon management method of claim 1, wherein the replacing the first icon with the second icon comprising:
displaying a list of videos;
detecting a video is selected from the list of videos; and
replacing the first icon with a thumbnail icon of the selected video.

5. The desktop icon management method of claim 4, further comprising:
capturing a video frame from the selected video; and
considering the video frame as the thumbnail icon of the selected video.

6. The desktop icon management method of claim 1, wherein the first item further comprises a third menu item, the method further comprising:
removing the first icon from the GUI desktop when the third menu item is selected.

7. The desktop icon management method of claim 1, wherein the displaying the first menu comprises:
displaying the first menu in a region of the GUI desktop adjacent to the first icon.

8. The desktop icon management method of claim 1, wherein the displaying the second menu comprises:
displaying the second menu in a region of the GUI desktop adjacent to the first menu item.

9. A computing device comprising:
a memory;
a processor coupled to the memory;
one or more programs stored in the memory and executable by the processor, the one or more programs comprising:
an icon placing module configured to place a first icon on a graphical user interface (GUI) desktop;
an input detecting module configured to detect whether a press-and-hold input is made with respect to the first icon;
a first menu displaying module configured to display a first menu when the press-and-hold input is made with respect to the first icon, the first menu comprising a first menu item;
a second menu displaying module configured to display a second menu when the first menu item is selected, the second menu comprising a second menu item; and
an icon replacing module configured to replace the first icon with a second icon on the GUI desktop when the second menu item is selected.

10. The computing device of claim 9, wherein the icon replacing module is configured to display a list of application programs, and when one of the application programs is selected from the list, replace the first icon with a shortcut icon of the selected application program.

11. The computing device of claim 9, wherein the icon replacing module is configured to display a list of pictures, and when one of the pictures is selected from the list, replace the first icon with a thumbnail icon of the selected picture.

12. The computing device of claim 9, wherein the icon replacing module is configured to display a list of videos, and when one of the videos is selected from the list, replace the first icon with a thumbnail icon of the selected video.

13. The computing device of claim 12, wherein the icon replacing module is configured to capture a video frame from the selected video and consider the video frame as the thumbnail icon of the selected video.

14. The computing device of claim 9, wherein the first item further comprises a third menu item, the one or more programs further comprises an icon removing module, when the third menu item is selected, the icon removing module is configured to remove the first icon from the GUI desktop.

15. The computing device of claim 9, wherein the first menu displaying module is configured to display the first menu in a region of the GUI desktop adjacent to the first icon.

16. The computing device of claim 9, wherein the second menu displaying module is configured to display the second menu in a region of the GUI desktop adjacent to the first menu item.

17. A desktop icon management method, comprising:
placing a first icon on a graphical user interface (GUI);
first receiving a selection within the GUI of the first icon;
first displaying in the GUI a first menu in response to the first receiving, the first menu including a first menu item;
second receiving a selection within the GUI of the first menu item within the displayed first menu;
second displaying in the GUI a second menu in response to the second receiving, the second menu including a second menu item; and
second receiving a selection within the GUI of the second menu item within the displayed second menu;
replacing on the GUI, in response to the second receiving, the first icon with a second icon representing the second menu item.

18. The method of claim 17, wherein the selection of the first icon is via a press and hold command for the first menu item.
